(19) United States
(12) Patent Application Publication
(10) Pub. No.: US 2025/0012726 A1
(43) Pub. Date: Jan. 9, 2025

(54) INSPECTION APPARATUS AND INSPECTION METHOD

(71) Applicant: Lasertec Corporation, Yokohama (JP)

(72) Inventors: Shota FUJIKI, Yokohama (JP); Yoshihiro NISHIMURA, Yokohama (JP)

(73) Assignee: Lasertec Corporation, Yokohama (JP)

(21) Appl. No.: 18/765,608

(22) Filed: Jul. 8, 2024

(30) Foreign Application Priority Data
Jul. 6, 2023 (JP) 2023-111607

(51) Int. Cl. G01N 21/64; G01N 21/65

(52) U.S. Cl. CPC G01N 21/6489; G01N 21/65; G01N 2201/0636

(57) ABSTRACT

An inspection apparatus according to an embodiment includes pulsed light generation means for generating pulsed light having a wavelength longer than a wavelength of light corresponding to a bandgap of a sample, the pulsed light subjecting the sample to multiphoton excitation, light focusing means including an objective lens, for focusing the pulsed light on the sample through the objective lens, and for passing, through the objective lens, light including photoluminescence light and Raman scattered light produced from the sample by irradiation with the pulsed light, first detection means for detecting the photoluminescence light passed through the objective lens, and second detection means for detecting the Raman scattered light passed through the objective lens.

### INCORPORATION BY REFERENCE

This application is based upon and claims the benefit of priority from Japanese patent application No. 2023-111607, filed on Jul. 6, 2023, the disclosure of which is incorporated herein in its entirety by reference.

### BACKGROUND

The present disclosure relates to an inspection apparatus and an inspection method.

Common photoluminescence measurement through use of photoluminescence light enables observation of an internal defect in which a semiconductor wafer has been altered in polytype or crystal. However, it is difficult with the common photoluminescence measurement to see a stress distribution without crystal alteration, such as a processing stress residue. Such a stress residue might cause denaturalization to a defect or a damage in a subsequent epitaxial process, thermal process, or the like. Thus, it is preferable to enable a stress within the crystal to be evaluated.

Raman spectroscopy measurement through use of Raman scattered light is effective for such evaluation. Therefore, an inspection apparatus based on photoluminescence measurement and with combination therewith of Raman spectroscopy measurement is desired. However, in the case of using the common photoluminescence measurement as a base, band-edge luminescence will occur at wavelengths in the immediate vicinity of excitation light. Thus, performing Raman spectroscopy measurement using excitation light of photoluminescence measurement raises problems such as band-edge luminescence hiding Raman scattered light which is a weak signal. Therefore, in order to combine Raman spectroscopy measurement, measures such as using a light source at a wavelength different from the wavelength of a light source for photoluminescence measurement needs to be taken.

### SUMMARY

For example, Japanese Unexamined Patent Application Publication No. 2003-194718 discloses, as a method for detecting an internal defect of a sample including a wide-bandgap semiconductor represented by gallium nitride (GaN) or the like, multiphoton excitation photoluminescence measurement that involves focusing laser light having a wavelength longer than the wavelength of light corresponding to the bandgap on the sample and detecting photoluminescence light obtained by multiphoton excitation. Japanese Unexamined Patent Application Publication No. 2003-194718 also discloses further combining multiphoton excitation photoluminescence measurement with Raman spectroscopy measurement, thereby detecting internal lattice vibration. However, Japanese Unexamined Patent Application Publication No. 2003-194718 fails to disclose using the same wavelength for excitation light to be used for multiphoton excitation photoluminescence measurement and excitation light to be used for Raman spectroscopy measurement, and fails to disclose a specific configuration.

An inspection apparatus and an inspection method are desired which enable both photoluminescence light and Raman scattered light to be detected with a simple configuration including a light source to be used for multiphoton excitation photoluminescence measurement and which can advance crystal evaluation.

The present disclosure has been made in view of these problems and provides an inspection apparatus and an inspection method which enable both photoluminescence light and Raman scattered light to be detected with a simple configuration and which can advance crystal evaluation.

An inspection apparatus according to an aspect of the present embodiment includes pulsed light generation means for generating pulsed light having a wavelength longer than a wavelength of light corresponding to a bandgap of a sample, the pulsed light subjecting the sample to multiphoton excitation, light focusing means including an objective lens, for focusing the pulsed light on the sample through the objective lens, and for passing, through the objective lens, light including photoluminescence light and Raman scattered light produced from the sample by irradiation with the pulsed light, first detection means for detecting the photoluminescence light passed through the objective lens, and second detection means for detecting the Raman scattered light passed through the objective lens.

In the above-described inspection apparatus, the sample may include a semiconductor wafer.

In the above-described inspection apparatus, the light focusing means may further include a half-silvered mirror located between the objective lens and the second detection means on an optical path of the pulsed light and configured to pass either one of the pulsed light and the Raman scattered light and reflect the other one, a first pin hole located between the half-silvered mirror and the pulsed light generation means, and a second pin hole located between the second detection means and the half-silvered mirror. At least the second detection means may detect the Raman scattered light produced from a portion of the sample where the pulsed light is brought into focus.

In the above-described inspection apparatus, the half-silvered mirror may reflect the pulsed light and pass the Raman scattered light and the photoluminescence light, or may pass the pulsed light and reflect the Raman scattered light and the photoluminescence light.

In the above-described inspection apparatus, the light focusing means may further include a dichroic mirror located between the half-silvered mirror and both the first detection means and the second detection means, and the dichroic mirror may pass either one of the photoluminescence light and the Raman scattered light and reflect the other one.

In the above-described inspection apparatus, the dichroic mirror may reflect or pass light at a central wavelength of the pulsed light and in a wavelength range of at most ±100 nm around the central wavelength to guide light in the wavelength range to the second detection means.

In the above-described inspection apparatus, the light focusing means may further include a first filter located between the dichroic mirror and the first detection means, the first filter may include a filter which is at least any of a short pass filter configured to pass light having a short wavelength of less than or equal to 400 nm, a long pass filter configured to pass light having a long wavelength of more than 700 nm, and a bandpass filter configured to pass light of more than 400 nm and less than or equal to 700 nm, and the first detection means may detect the photoluminescence light passed through the first filter.

In the above-described inspection apparatus, the light focusing means may further include a second filter located between the dichroic mirror and the second detection means, the second filter may include a filter configured to block at least light at a central wavelength of the pulsed light, and the second detection means may detect the Raman scattered light passed through the second filter.

In the above-described inspection apparatus, the second filter may include a filter configured to block light of less than or equal to the central wavelength of the pulsed light or more than or equal to the central wavelength of the pulsed light.

In the above-described inspection apparatus, a wavelength of the pulsed light may include a wavelength in a visible light region.

An inspection method according to an aspect of the present embodiment includes a pulsed light generation step of generating pulsed light having a wavelength longer than a wavelength of light corresponding to a bandgap of a sample, the pulsed light subjecting the sample to multiphoton excitation, a light focusing step of focusing the pulsed light on the sample through an objective lens and passing, through the objective lens, light including photoluminescence light and Raman scattered light produced from the sample by irradiation with the pulsed light, and a detection step of causing first detection means to detect the photoluminescence light passed through the objective lens and causing second detection means to detect the Raman scattered light passed through the objective lens.

In the above-described inspection method, the sample may include a semiconductor wafer.

In the above-described inspection method, in the light focusing step, a half-silvered mirror located between the objective lens and the second detection means on an optical path of the pulsed light may be caused to pass either one of the pulsed light and the Raman scattered light and reflect the other one, and at least the second detection means may be caused to detect the Raman scattered light produced from a portion of the sample where the pulsed light is brought into focus by a first pin hole located between the half-silvered mirror and the pulsed light generation means and a second pin hole located between the second detection means and the half-silvered mirror.

In the above-described inspection method, the half-silvered mirror may reflect the pulsed light and pass the Raman scattered light and the photoluminescence light, or may pass the pulsed light and reflect the Raman scattered light and the photoluminescence light.

In the above-described inspection method, in the light focusing step, a dichroic mirror located between the half-silvered mirror and both the first detection means and the second detection means may be caused to pass either one of the photoluminescence light and the Raman scattered light and reflect the other one.

In the above-described inspection method, the dichroic mirror may reflect or pass light at a central wavelength of the pulsed light and in a wavelength range of at most ±100 nm around the central wavelength to guide light in the wavelength range to the second detection means.

In the above-described inspection method, in the light focusing step, the first detection means may be caused to detect the photoluminescence light passed through a first filter located between the dichroic mirror and the first detection means, the first filter including a filter which is at least any of a short pass filter configured to pass light having a short wavelength of less than or equal to 400 nm, a long pass filter configured to pass light having a long wavelength of more than 700 nm, and a bandpass filter configured to pass light of more than 400 nm and less than or equal to 700 nm.

In the above-described inspection method, in the light focusing step, the second detection means may be caused to detect the Raman scattered light passed through a second filter located between the dichroic mirror and the second detection means, the second filter including a filter configured to block at least light at a central wavelength of the pulsed light.

In the above-described inspection method, the second filter may further include a filter configured to block light of less than or equal to the central wavelength of the pulsed light or more than or equal to the central wavelength of the pulsed light.

In the above-described inspection method, a wavelength of the pulsed light may include a wavelength in a visible light region.

According to the present disclosure, an inspection apparatus and an inspection method can be provided which enable both photoluminescence light and Raman scattered light to be detected with a simple configuration and which can advance crystal evaluation.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a configuration diagram illustrating an inspection apparatus according to a first embodiment;

FIG. 2 is a flowchart illustrating an inspection method according to the first embodiment;

FIG. 3 is a configuration diagram illustrating an inspection apparatus according to a second embodiment;

FIG. 4 is a configuration diagram illustrating an inspection apparatus according to a third embodiment;

FIG. 5 is a graph illustrating transmission characteristics of a dichroic mirror in the inspection apparatus according to the third embodiment, the horizontal axis indicating wavelength and the vertical axis indicating transmittance;

FIG. 6 is a graph illustrating characteristics of a filter in the inspection apparatus according to the third embodiment, the horizontal axis indicating wavelength and the vertical axis indicating transmittance;

FIG. 7 is a graph illustrating light detected by first detection means and second detection means in the inspection apparatus according to the third embodiment, the horizontal axis indicating wavelength and the vertical axis indicating transmittance;

FIG. 8 is a graph illustrating light detected by the first detection means and the second detection means in the inspection apparatus according to the third embodiment, the horizontal axis indicating wavelength and the vertical axis indicating transmittance; and

FIG. 9 is a graph illustrating light detected by the first detection means and the second detection means in the inspection apparatus according to the third embodiment, the horizontal axis indicating wavelength and the vertical axis indicating transmittance.

### DESCRIPTION OF EMBODIMENTS

Hereinafter, embodiments of the present disclosure will be described with reference to the drawings. The following description indicates suitable embodiments of the present disclosure, and the scope of the present disclosure is not limited to the following embodiments. In the following description, elements denoted by the same reference characters indicate substantially similar content.

### First Embodiment

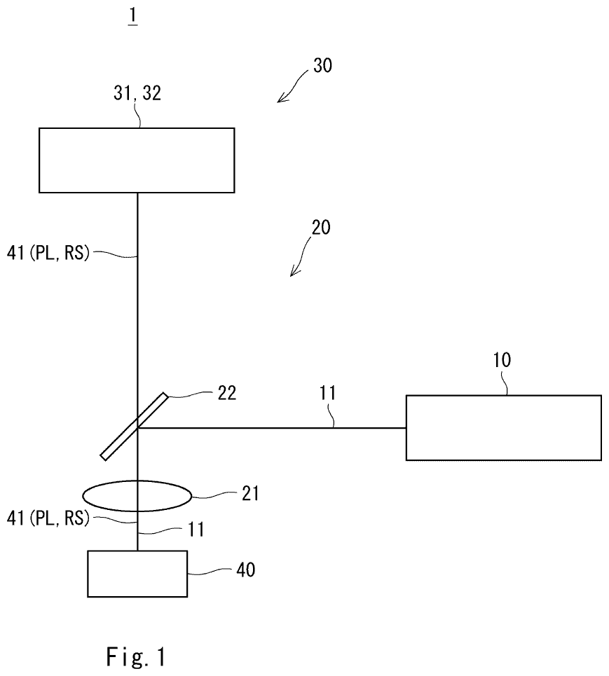

An inspection apparatus and an inspection method according to a first embodiment will be described. FIG. 1 is a configuration diagram illustrating an inspection apparatus 1 according to the first embodiment. As shown in FIG. 1, the inspection apparatus 1 according to the present embodiment includes pulsed light generation means 10 (pulsed light generation unit), light focusing means 20 (light focusing unit), and detection means 30 (detection unit). The inspection apparatus 1 irradiates a sample 40 such as a semiconductor wafer with pulsed light 11 having a wavelength longer than the wavelength of light corresponding to the bandgap of the sample 40. The inspection apparatus 1 thereby observes photoluminescence light PL, obtained by multiphoton excitation derived from the pulsed light 11, and Raman scattered light RS derived from the pulsed light 11. The diagram schematically only shows optical axes of light such as the pulsed light 11, the photoluminescence light PL, and the Raman scattered light RS. The sample 40 includes a semiconductor wafer formed of semiconductor, for example. Specifically, the semiconductor material may contain a wide-bandgap compound semiconductor such as silicon carbide (SiC) and GaN. However, the sample 40 is not limited to a semiconductor wafer as long as a crystal having a bandgap is contained.

The pulsed light generation means 10 generates the pulsed light 11 having a wavelength longer than the wavelength of light corresponding to the bandgap of the sample 40. The pulsed light generation unit is configured to generate the pulsed light 11. The pulsed light generation means 10 generates the pulsed light 11 for subjecting the sample 40 to multiphoton excitation.

In the case of common photoluminescence measurement, the sample 40 is irradiated with light having energy greater than energy of the bandgap of the sample 40. The photoluminescence light PL discharged when the sample 40 transitions from the excited state to the ground state is thereby measured.

On the other hand, in the case of photoluminescence measurement by multiphoton excitation, the sample 40 is irradiated with light having energy of approximately one-half, one-third, or one-fourth or less of energy of the bandgap of the sample 40. Then, the photoluminescence light PL discharged when the sample transitions from the excited state to the ground state by multiple photons such as two photons, three photons, or four photons or more photons is measured. As described, in the case of photoluminescence measurement by multiphoton excitation, the pulsed light 11 having a wavelength longer than the wavelength of light corresponding to the bandgap of the sample 40 is used. The pulsed light generation means 10 is preferably implemented by a femtosecond laser or the like that can generate the pulsed light 11 at a high power. Note that the pulsed light generation means 10 is not limited to the femtosecond laser.

As to the specs of the pulsed light 11, infrared light of power of 3 W or the like having a central wavelength of 1040 nm, for example, may be adopted. In this case, the photoluminescence light PL through three-photon excitation can be produced for the sample 40 such as SiC and GaN. Alternatively, as to the specs of the pulsed light 11, visible light of power of 1 W or the like having a central wavelength of 520 nm, for example, may be adopted. In this case, the photoluminescence light PL through two-photon excitation can be produced for the sample 40 such as SiC and GaN. As described, the wavelength of the pulsed light 11 may include a wavelength in the infrared light region or may include a wavelength in the visible light region, for example.

The light focusing means 20 includes an objective lens 21. Note that the light focusing means 20 may include another optical member such as a half-silvered mirror 22 in addition to the objective lens 21. The light focusing means 20 focuses the pulsed light 11 on the sample 40 through the objective lens 21. In addition, the light focusing means 20 passes, through the objective lens 21, light 41 produced from the sample 40 by irradiation with the pulsed light 11. The light focusing unit is configured to focus the pulsed light on the sample through the objective lens, and to pass, through the objective lens, light including photoluminescence light and Raman scattered light produced from the sample by irradiation with the pulsed light. The light focusing means 20 thereby guides the light 41 produced from the sample 40 to the detection means 30. The light 41 produced from the sample 40 includes the photoluminescence light PL and the Raman scattered light RS. In the diagram, the light 41 including the photoluminescence light PL and the Raman scattered light RS are shown as 41 (PL, RS).

The detection means 30 includes first detection means 31 and second detection means 32. The first detection means 31 detects the photoluminescence light PL passed through the objective lens 21. The first detection unit is configured to detect the photoluminescence light PL passed through the objective lens 21. The first detection means 31 includes a detector capable of detecting the photoluminescence light PL, such as, for example, a CCD (Charge Coupled Device) sensor, TDI (Time Delay Integration) camera, or PMT (Photomultiplier Tube). The second detection means 32 detects the Raman scattered light RS passed through the objective lens 21. The second detection unit is configured to detect the Raman scattered light RS passed through the objective lens 21. The second detection means 32 includes a detector capable of detecting the Raman scattered light RS, such as a CCD or PMT. The second detection means 32 may further include a spectroscope.

The first detection means 31 and the second detection means 32 in the detection means 30 may be configured integrally. For example, the detection means 30 may have the functions of the first detection means 31 and the second detection means 32 to detect both the photoluminescence light PL and the Raman scattered light RS. Alternatively, the detection means 30 may switch the first detection means 31 and the second detection means 32 with switching means, thereby detecting the photoluminescence light PL and the Raman scattered light RS.

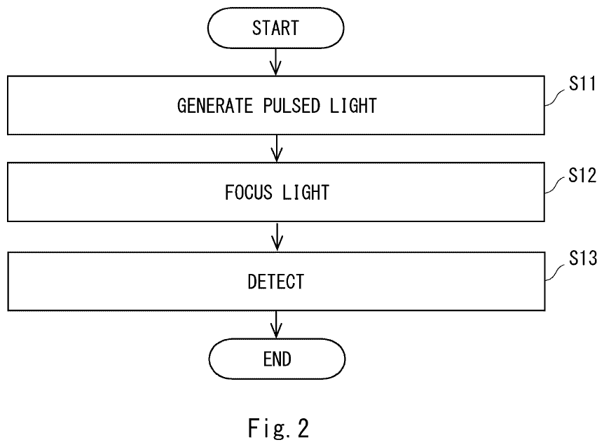

FIG. 2 is a flowchart illustrating an inspection method according to the first embodiment. As shown in FIG. 2, the inspection method of the present embodiment includes pulsed light generation step S11, light focusing step S12, and detection step S13.

In the pulsed light generation step S11, first, the pulsed light 11 for subjecting the sample 40 to multiphoton excitation is generated. For example, the pulsed light generation means 10 is caused to generate the pulsed light 11 having a wavelength longer than the wavelength of light corresponding to the bandgap of the sample 40.

Next, in the light focusing step S12, the pulsed light 11 is focused on the sample 40 through the objective lens 21. In addition, the light 41 produced from the sample 40 by irradiation with the pulsed light 11 is passed through the objective lens 21. The light 41 includes the photoluminescence light PL and the Raman scattered light RS.

Next, in the detection step S13, the photoluminescence light PL passed through the objective lens 21 is detected by the first detection means 31. The Raman scattered light RS passed through the objective lens 21 is also detected by the second detection means 32.

Next, effects of the present embodiment will be described. The present embodiment irradiates the sample 40 with the pulsed light 11 having a wavelength longer than the wavelength of light corresponding to the bandgap of the sample 40, thereby performing multiphoton excitation of the sample 40. Both the photoluminescence light PL and the Raman scattered light RS are thereby detected. Photoluminescence measurement enables detection of a crystal defect of the sample 40. Raman spectroscopy measurement enables detection of a distortion and stress within the sample 40. Hence, the present embodiment can detect not only a crystal defect of the sample 40, but also a plurality of types of internal abnormalities also including a distortion, stress, and the like.

Moreover, the present embodiment observes the photoluminescence light PL by multiphoton excitation of long-wavelength light, thereby performing measurement simultaneous with the Raman scattered light RS, which has been difficult with the common photoluminescence measurement through use of short-wavelength light. This enables the Raman scattered light RS produced at a place where the photoluminescence light PL is produced to be associated. Thus, both the photoluminescence light PL and the Raman scattered light RS can be detected with a simple configuration, and crystal evaluation can be advanced.

Even if one tries to detect the Raman scattered light RS simultaneously with the photoluminescence light PL based on the common photoluminescence measurement and with combination therewith of Raman spectroscopy measurement, wavelength bands of the photoluminescence light PL and the Raman scattered light RS are substantially the same, and the Raman scattered light RS which is weaker is buried, so that it is difficult to detect the Raman scattered light RS with an effective resolution. In addition, in a compound semiconductor such as SiC, ultraviolet light is used for the common excitation light of photoluminescence measurement. Thus, a detector that detects the Raman scattered light RS for ultraviolet light has a very narrow range, which makes handling very difficult.

In contrast, the present embodiment is based on the photoluminescence measurement through use of multiphoton excitation and combines Raman spectroscopy measurement. In addition, in photoluminescence measurement through use of multiphoton excitation, light having a wavelength from the visible light region to the infrared light region is used as excitation light. The above-described problems can thereby be solved.

Moreover, since a laser light source having a high output power required for multiphoton excitation is used for the pulsed light generation means 10, the weak Raman scattered light RS can be detected at a sufficient intensity and a good S/N ratio. The Raman scattered light RS that enables evaluation of a stress within the crystal can thereby be observed. For example, the amount of the Stokes shift in Raman spectroscopy measurement may be represented by grayscale, or a reference Stokes wavenumber may be fixed, and an intensity ratio at that wavenumber may be displayed. A stress within the sample 40 can be detected by the intensity of the Stokes shift.

### Second Embodiment

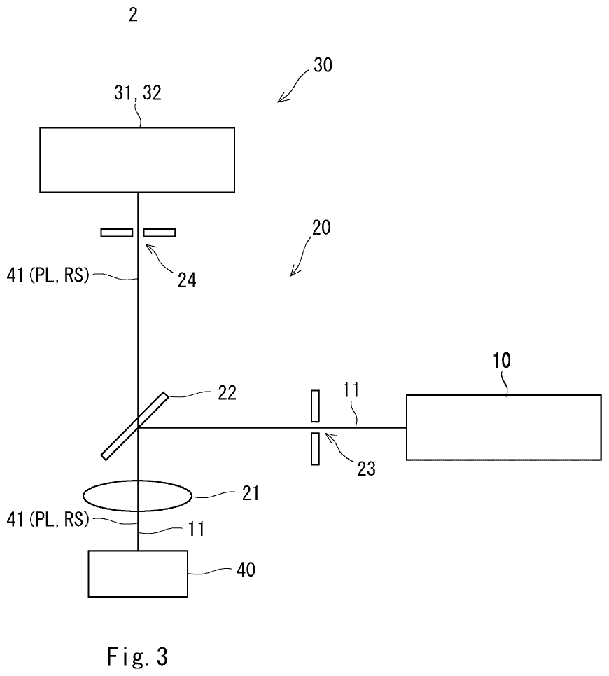

Next, an inspection apparatus according to a second embodiment will be described. In the inspection apparatus of the present embodiment, the light focusing means 20 includes a confocal optical system. FIG. 3 is a configuration diagram illustrating the inspection apparatus according to the second embodiment. As shown in FIG. 3, in an inspection apparatus 2 of the present embodiment, the light focusing means 20 further includes the half-silvered mirror 22, a first pin hole 23, and a second pin hole 24 in addition to the objective lens 21. Note that the light focusing means 20 may further include another optical member in addition to the above-described members.

The half-silvered mirror 22 is located between the objective lens 21 and the second detection means 32 on an optical path of the pulsed light 11. The half-silvered mirror 22 passes either one of the pulsed light 11 and the Raman scattered light RS and reflects the other one. For example, in the inspection apparatus 2 shown in FIG. 3, the half-silvered mirror 22 reflects the pulsed light 11 and passes the light 41 including the Raman scattered light RS. In addition, in this case, the half-silvered mirror 22 also passes the light 41 including the photoluminescence light PL. Note that the positions of the pulsed light generation means 10 and the detection means 30 with respect to the objective lens 21 may be exchanged so that the half-silvered mirror 22 passes the pulsed light 11 and reflects the light 41 including the Raman scattered light RS. In addition, in this case, the half-silvered mirror 22 also reflects the light 41 including the photoluminescence light PL.

The first pin hole 23 is located between the half-silvered mirror 22 and the pulsed light generation means 10. The second pin hole 24 is located between the second detection means 32 and the half-silvered mirror 22. The first pin hole 23 and the second pin hole 24 are located so as to form a confocal optical system. In other words, at least the second detection means 32 detects the Raman scattered light RS produced from the portion of the sample 40 where the pulsed light 11 is brought into focus.

In an inspection method of the present embodiment, the half-silvered mirror 22 located between the objective lens 21 and the second detection means 32 on the optical path of the pulsed light 11 is caused to pass either one of the pulsed light 11 and the Raman scattered light RS and reflect the other one in the light focusing step S12. At least the second detection means 32 is caused to detect the Raman scattered light RS produced from the portion of the sample 40 where the pulsed light 11 is brought into focus by the first pin hole 23 located between the half-silvered mirror 22 and the pulsed light generation means 10 and the second pin hole 24 located between the second detection means 32 and the half-silvered mirror 22.

According to the present embodiment, the light focusing means 20 forms the confocal optical system. Thus, the second detection means 32 detects the Raman scattered light RS produced from the portion of the sample 40 where the pulsed light 11 is brought into focus, so that the Raman scattered light RS can be increased in intensity. In addition, multiphoton excitation requiring the energy of multiple photons occurs in a region where the pulsed light is brought into focus. Therefore, the first detection means 31 detects the photoluminescence light PL produced from the portion of the sample 40 where the pulsed light 11 is brought into focus. This enables the photoluminescence light PL and the Raman scattered light RS to be associated with each other with higher accuracy, and crystal evaluation of the sample 40 can be advanced.

### Third Embodiment

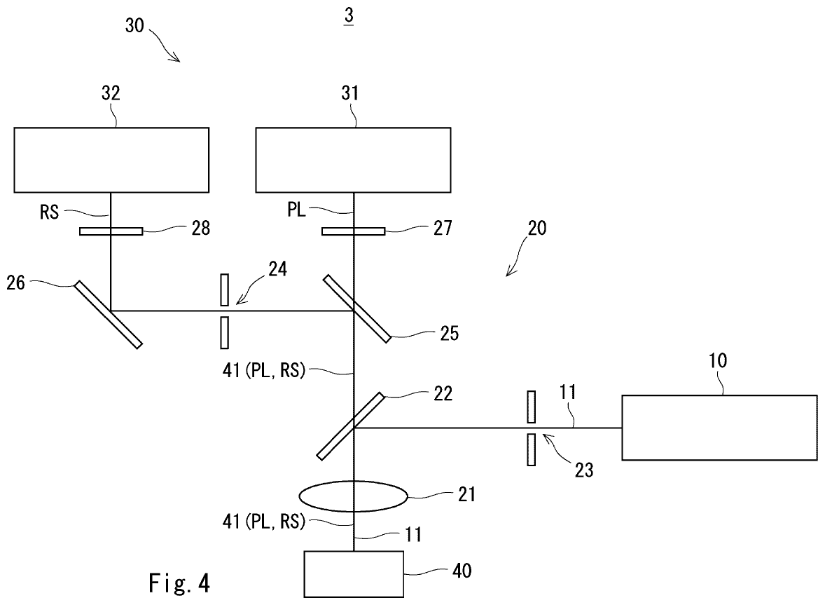

Next, an inspection apparatus and an inspection method according to a third embodiment will be described. The inspection apparatus of the present embodiment separates the photoluminescence light PL and the Raman scattered light RS by a dichroic mirror. FIG. 4 is a configuration diagram illustrating the inspection apparatus according to the third embodiment. As shown in FIG. 4, the light focusing means 20 in an inspection apparatus 3 of the present embodiment further includes a dichroic mirror 25. In addition, the light focusing means 20 may further include a filter 27 and a filter 28. Note that the light focusing means may further include another optical member such as a mirror 26 in addition to the above-described optical members.

The dichroic mirror 25 is located between the half-silvered mirror 22 and both the first detection means 31 and the second detection means 32. The dichroic mirror 25 passes either one of the photoluminescence light PL and the Raman scattered light RS and reflects the other one.

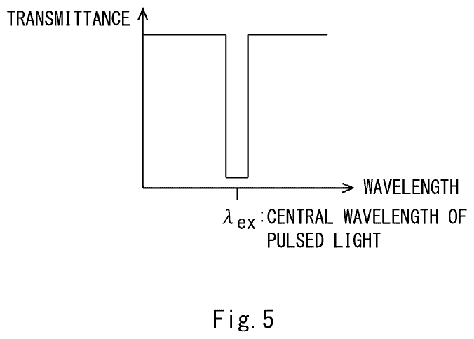

FIG. 5 is a graph illustrating transmission characteristics of the dichroic mirror 25 in the inspection apparatus 3 according to the third embodiment, the horizontal axis indicating wavelength and the vertical axis indicating transmittance. As shown in FIG. 5, the dichroic mirror 25 reflects or passes light in a wavelength range in the vicinity of the central wavelength of the pulsed light 11 to guide the light 41 in the wavelength range to the second detection means 32. The light 41 in the wavelength range includes the Raman scattered light RS in addition to the pulsed light 11. The wavelength range is ±100 nm of the central wavelength of the pulsed light 11, for example. Alternatively, the wavelength range may be ±50 nm of the central wavelength of the pulsed light 11, for example.

As an example, the dichroic mirror 25 reflects the light 41 in the wavelength range including the Raman scattered light RS and passes the light 41 including the other photoluminescence light PL, as shown in FIG. 4. The light 41 in the wavelength range including the Raman scattered light RS reflected by the dichroic mirror 25 passes through the second pin hole 24. The second pin hole 24 is located between the dichroic mirror 25 and the second detection means 32. The light 41 passed through the second pin hole 24 is reflected by the mirror 26 to enter the filter 28. The filter 28 is located between the dichroic mirror 25 and the second detection means 32.

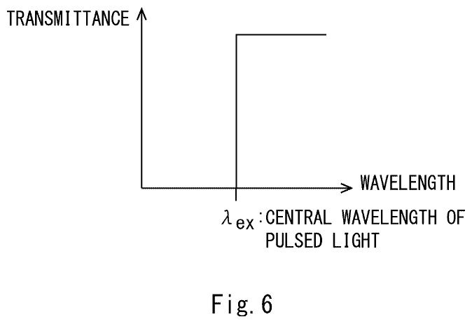

FIG. 6 is a graph illustrating characteristics of the filter 28 in the inspection apparatus 3 according to the third embodiment, the horizontal axis indicating wavelength and the vertical axis indicating transmittance. As shown in FIG. 6, the filter 28 includes a filter that blocks at least light at the central wavelength of the pulsed light 11 for extracting the Raman shift. The filter 28 may include an edge filter, for example. Specifically, the filter 28 includes a filter that blocks light of less than or equal to the central wavelength of the pulsed light 11 or more than or equal to the central wavelength of the pulsed light 11. Note that it is desirable that the second detection means 32 should detect high-intensity Stokes scattering in the Raman scattered light RS. Thus, the filter 28 is preferably implemented by a filter having long pass characteristics that blocks light of less than or equal to the central wavelength of the pulsed light 11 and passes the light 41 on the long-wavelength side of the central wavelength. The second detection means 32 thus detects the Raman scattered light RS passed through the filter 28. Note that the filter 28 may have switching means for switching a plurality of filters. The switching means switches the filters in accordance with the wavelength of the Raman scattered light RS as observed.

As shown in FIG. 4, the light 41 including the photoluminescence light PL passed through the dichroic mirror 25 enters the filter 27. The filter 27 is located between the dichroic mirror 25 and the first detection means 31. The filter 27 includes a filter which is at least any of a short pass filter that passes light having a short wavelength of less than or equal to 400 nm, a long pass filter that passes light having a long wavelength of more than 700 nm, and a bandpass filter that passes light of more than 400 nm and less than or equal to 700 nm. Note that the filter 27 may have switching means for switching a plurality of filters. The switching means switches the filters in accordance with the wavelength of the photoluminescence light PL as observed.

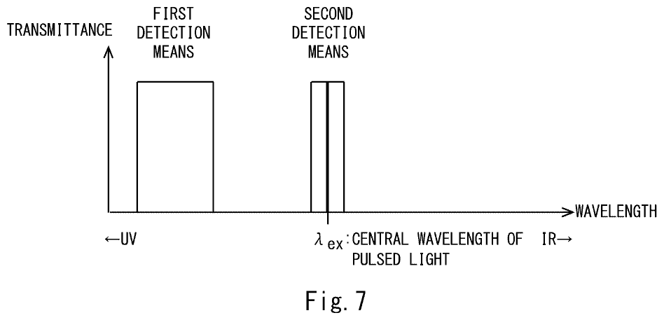

FIG. 7 to FIG. 9 are graphs each illustrating the wavelength bands of the light 41 detected by the first detection means 31 and the second detection means 32 in the inspection apparatus 3 according to the third embodiment, the horizontal axis indicating wavelength and the vertical axis indicating transmittance and indicating the intensity of the light 41 detected by the first detection means 31 and the second detection means 32. As shown in FIG. 7, the first detection means 31 may detect the light 41 passed through a short pass filter that passes light having a short wavelength of less than or equal to 400 nm. In this case, band-edge luminescence of SiC or the like can be observed.

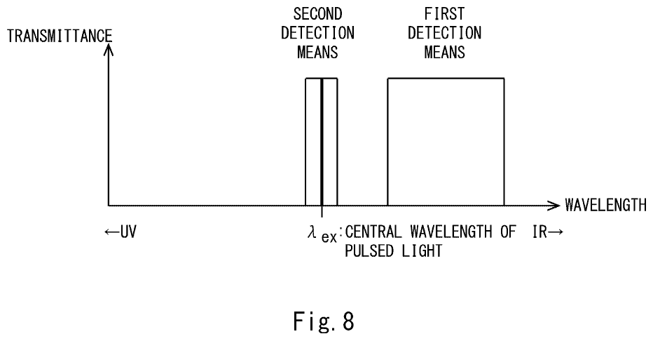

Alternatively, as shown in FIG. 8, the first detection means 31 may detect the light 41 passed through a long pass filter that passes light having a wavelength longer than 700 nm. In this case, the photoluminescence light PL from basal plane dislocation (BPD) present in a semiconductor material such as SiC and called a killer defect can be observed.

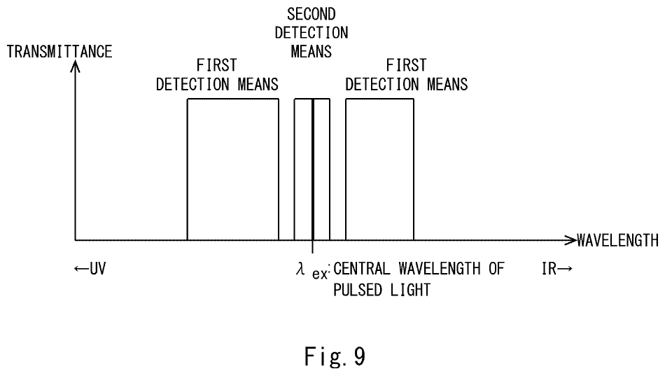

Still alternatively, as shown in FIG. 9, the first detection means 31 may detect the light 41 passed through the bandpass filter that passes light of more than 400 nm and less than or equal to 700 nm. In this case, the photoluminescence light PL such as impurity luminescence, defect level luminescence, and stacking fault luminescence of a wide-bandgap semiconductor such as SiC can be observed. The first detection means 31 thus detects the photoluminescence light PL passed through the filter 27.

In the inspection method of the present embodiment, the dichroic mirror 25 is caused to pass either one of the photoluminescence light PL and the Raman scattered light RS and reflect the other one in the light focusing step S12. In addition, the first detection means 31 is caused to detect the photoluminescence light PL passed through the filter 27. In addition, the second detection means 32 is caused to detect the Raman scattered light RS passed through the filter 28.

According to the present embodiment, an optical path of the photoluminescence light PL detected by the first detection means 31 and an optical path of the Raman scattered light RS detected by the second detection means 32 can be separated by the dichroic mirror 25. Hence, the optical path of the Raman scattered light RS is configured by a confocal optical system, and the optical path of the photoluminescence light PL may not be configured by a confocal optical system.

In photoluminescence measurement by multiphoton excitation, the photoluminescence light PL is highly likely to be produced from a portion where the pulsed light is brought into focus, that is, a portion in which the photon density is high. Hence, the first detection means 31 detects the photoluminescence light PL produced from such a portion where the pulsed light 11 is brought into focus. Therefore, without having a confocal optical system including the second pin hole 24 and the like, the first detection means 31 can substantially detect the photoluminescence light PL produced from the portion where the pulsed light 11 is brought into focus.

On the other hand, in the present embodiment, the second detection means 32 detects the Raman scattered light RS produced from the portion where the pulsed light 11 is brought into focus by the confocal optical system. This enables the photoluminescence light PL and the Raman scattered light RS to be associated with each other with high accuracy, and crystal evaluation of the sample 40 can be advanced.

Since the present embodiment eliminates the need to configure the optical path of the photoluminescence light PL by a confocal optical system, optical members can be reduced.

Since the optical path of the photoluminescence light PL and the optical path of the Raman scattered light RS can be separated, the filter 27 and the filter 28 which are different from each other in correspondence to detection targets, respectively, can be located on the respective optical paths. Hence, desired wavelength ranges can be detected respectively for the photoluminescence light PL and the Raman scattered light RS.

It is desirable that the first pin hole 23 and the second pin hole 24 should have variable sizes. By varying the first pin hole 23 and the second pin hole 24 in size, the portion of the sample 40 where the pulsed light 11 is brought into focus can be varied in size. Hence, an observation range in the sample 40 can be varied in size. For example, by varying the first pin hole 23 and the second pin hole 24 in size in correspondence to the observation range depending on a probability of occurrence of the photoluminescence light PL by multiphoton excitation, the photoluminescence light PL and the Raman scattered light RS can be associated with each other with higher accuracy. In addition, although it has been described that the optical path of the photoluminescence light PL is not configured by a confocal optical system, the optical path of the photoluminescence light PL may also be configured by a confocal optical system similarly to the optical path of the Raman scattered light RS.

Although the embodiments of the present disclosure have been described above, the present disclosure includes appropriate modifications without impairing the object and advantages of the disclosure, and is not limited by the above-described embodiments. In addition, any combination of the respective components of the first to third embodiments also falls within the technical idea of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An inspection apparatus comprising:
pulsed light generation unit configured to generate pulsed light having a wavelength longer than a wavelength of light corresponding to a bandgap of a sample, the pulsed light subjecting the sample to multiphoton excitation;
light focusing unit configured to include an objective lens, to focus the pulsed light on the sample through the objective lens, and to pass, through the objective lens, light including photoluminescence light and Raman scattered light produced from the sample by irradiation with the pulsed light;
first detection unit configured to detect the photoluminescence light passed through the objective lens; and
second detection unit configured to detect the Raman scattered light passed through the objective lens.

2. The inspection apparatus according to claim 1, wherein the sample includes a semiconductor wafer.

3. The inspection apparatus according to claim 1, wherein
the light focusing unit further includes
a half-silvered mirror located between the objective lens and the second detection unit on an optical path of the pulsed light and configured to pass either one of the pulsed light and the Raman scattered light and reflect the other one,
a first pin hole located between the half-silvered mirror and the pulsed light generation unit, and
a second pin hole located between the second detection unit and the half-silvered mirror, and
at least the second detection unit detects the Raman scattered light produced from a portion of the sample where the pulsed light is brought into focus.

4. The inspection apparatus according to claim 3, wherein the half-silvered mirror reflects the pulsed light and passes the Raman scattered light and the photoluminescence light, or passes the pulsed light and reflects the Raman scattered light and the photoluminescence light.

5. The inspection apparatus according to claim 4, wherein
the light focusing unit further includes a dichroic mirror located between the half-silvered mirror and both the first detection unit and the second detection unit, and
the dichroic mirror passes either one of the photoluminescence light and the Raman scattered light and reflects the other one.

6. The inspection apparatus according to claim 5, wherein the dichroic mirror reflects or passes light at a central wavelength of the pulsed light and in a wavelength range of at most ±100 nm around the central wavelength to guide light in the wavelength range to the second detection unit.

7. The inspection apparatus according to claim 5, wherein
the light focusing unit further includes a first filter located between the dichroic mirror and the first detection unit,
the first filter includes a filter which is at least any of a short pass filter configured to pass light having a short wavelength of less than or equal to 400 nm, a long pass filter configured to pass light having a long wavelength of more than 700 nm, and a bandpass filter configured to pass light of more than 400 nm and less than or equal to 700 nm, and
the first detection unit detects the photoluminescence light passed through the first filter.

8. The inspection apparatus according to claim 5, wherein
the light focusing unit further includes a second filter located between the dichroic mirror and the second detection unit,
the second filter includes a filter configured to block at least light at a central wavelength of the pulsed light, and
the second detection unit detects the Raman scattered light passed through the second filter.

9. The inspection apparatus according to claim 8, wherein the second filter includes a filter configured to block light of less than or equal to the central wavelength of the pulsed light or more than or equal to the central wavelength of the pulsed light.

10. The inspection apparatus according to claim 1, wherein a wavelength of the pulsed light includes a wavelength in a visible light region.

11. An inspection method comprising:
a pulsed light generation step of generating pulsed light having a wavelength longer than a wavelength of light corresponding to a bandgap of a sample, the pulsed light subjecting the sample to multiphoton excitation;
a light focusing step of focusing the pulsed light on the sample through an objective lens and passing, through the objective lens, light including photoluminescence light and Raman scattered light produced from the sample by irradiation with the pulsed light; and
a detection step of causing first detection unit to detect the photoluminescence light passed through the objective lens and causing second detection unit to detect the Raman scattered light passed through the objective lens.

12. The inspection method according to claim 11, wherein the sample includes a semiconductor wafer.

13. The inspection method according to claim 11, wherein in the light focusing step,
a half-silvered mirror located between the objective lens and the second detection unit on an optical path of the pulsed light is caused to pass either one of the pulsed light and the Raman scattered light and reflect the other one, and
at least the second detection unit is caused to detect the Raman scattered light produced from a portion of the sample where the pulsed light is brought into focus by a first pin hole located between the half-silvered mirror and the pulsed light generation unit and a second pin hole located between the second detection unit and the half-silvered mirror.

14. The inspection method according to claim 13, wherein the half-silvered mirror reflects the pulsed light and passes the Raman scattered light and the photoluminescence light, or passes the pulsed light and reflects the Raman scattered light and the photoluminescence light.

15. The inspection method according to claim 14, wherein in the light focusing step, a dichroic mirror located between the half-silvered mirror and both the first detection unit and the second detection unit is caused to pass either one of the photoluminescence light and the Raman scattered light and reflect the other one.

16. The inspection method according to claim 15, wherein the dichroic mirror reflects or passes light at a central wavelength of the pulsed light and in a wavelength range of at most ±100 nm around the central wavelength to guide light in the wavelength range to the second detection unit.

17. The inspection method according to claim 15, wherein in the light focusing step, the first detection unit is caused to detect the photoluminescence light passed through a first filter located between the dichroic mirror and the first detection unit, the first filter including a filter which is at least any of a short pass filter configured to pass light having a short wavelength of less than or equal to 400 nm, a long pass filter configured to pass light having a long wavelength of more than 700 nm, and a bandpass filter configured to pass light of more than 400 nm and less than or equal to 700 nm.

18. The inspection method according to claim 15, wherein in the light focusing step, the second detection unit is caused to detect the Raman scattered light passed through a second filter located between the dichroic mirror and the second detection unit, the second filter including a filter configured to block at least light at a central wavelength of the pulsed light.

19. The inspection method according to claim 18, wherein the second filter further includes a filter configured to block light of less than or equal to the central wavelength of the pulsed light or more than or equal to the central wavelength of the pulsed light.

20. The inspection method according to claim 11, wherein a wavelength of the pulsed light includes a wavelength in a visible light region.
